(19) United States
(12) Patent Application Publication
(10) Pub. No.: US 2007/0092071 A1
(43) Pub. Date: Apr. 26, 2007

(54) System and method for identifying the source of a sales lead

(76) Inventor: Mathew L. Grell, Norcross, GA (US)

Correspondence Address: Mathew L. Grell, 4307 Jones Bridge Circle, Norcross, GA, 30092, US

(21) Appl. No.: 11/241,006

(22) Filed: Oct. 1, 2005

(51) Int. Cl. H04M 11/00

(52) U.S. Cl. 379/93.12

(57) ABSTRACT

A system and method for identifying the source the source of a sales lead, wherein such invention provides for identifying the source that prompted a call and/or sales lead on a communication network by providing the recipient of an accepted call or inquiry with such advertising source identifying information.

### TECHNICAL FIELD

The present version of the invention relates generally to telecommunications systems and more specifically to a method, system and apparatus for identifying the source of sales lead using conventional telecommunications infrastructure.

### BACKGROUND

The public switched telephone network (PSTN) has been in existence for many years and has been the primary network supporting the conventional telephone system. Until recently, the PSTN has been used exclusively for transmitting verbal communications between users at two or more terminating stations, such as telephones, positioned in different geographic locations. While the PSTN continues to be used for transmitting verbal communications, use of the PSTN has expanded greatly within the past twenty years to include data transmission between computers, Internet, and other such applications.

During the evolution of the PSTN, the mobile communications network simultaneously evolved to support primarily mobile telephones and other verbal communication devices. The mobile communications network evolved very similarly to the PSTN. The mobile communications network was first developed as a collection of towers covering individual geographic areas, referred to as cells, for transmitting verbal communications electronically between two mobile telephones or between a mobile telephone and a wire line telephone. Mobile communication devices were quickly reconfigured to enable users to send and transmit data across the mobile communications network using modems and other such devices. Shortly thereafter, text messaging, referred to as short message service (SMS), was developed for sending short text messages to mobile communication devices. SMS evolved into a system, commonly referred to as enhanced messaging service (EMS), which is capable of sending ring tones, operator logos, and other simple visual messages to EMS compliant mobile devices. EMS compliant mobile telephones also have the ability to send and receive a combination of simple media items, such as melodies, pictures, sounds, animations, modified text and standard text as an integrated message for viewing on display screens.

Within these systems various call identification methods are currently available which provide selected information to the call recipient regarding the incoming call to aid him or her in identifying that incoming call. These known call identification methods include features to display call information to the call recipient by sending and displaying a data message to the called station.

The call information (i.e., the data message) provided in these known call identification methods consists of, or at best is derived from, the phone number of the station from which the caller is placing the call, providing little more information than the calling station number to the called party.

These known methods typically identify the number of the station from which the calling party is placing the call from a unique code associated with that station from which the call is placed. Related methods will also display the caller's name, derived from the calling station number, or other limited data messages. Where the subscribing call recipient has installed the necessary hardware (i.e., digital display of some type or an integrated services digital network (ISDN) station), the station number from where the calling party is placing the call will be displayed. Where the call recipient has a conventional analog station, these identification services are unavailable without additional equipment. Further, the calling number will be available to the called party only where the calling party has not blocked the information.

This caller identification feature is implemented by transmitting the calling line identification to the called customer station in a data message—for example, to an analog station during a silent interval between ringing or to an ISDN station in the out-of-band D-channel used for call control signaling. With a known ‘call waiting’ feature where a caller-identifying data message is transmitted out-of-band, as for an ISDN station, a customer already engaged in an ongoing telephone conversation is informed of the caller identity for a second call that is coming in.

Call-announcement methods are also available for call identification. In the call announcement scheme, a text-to-speech converter generates speech signals from text retrieved from a database or more currently retrieves such signals from a database, for transmission to the called station. The database contains information associated with the calling party's number, specifically, the calling party's name. After answering the call, a subscribing call recipient will receive synthesized or spoken information consisting of the calling party's name and/or number. This service is made available to customers having conventional analog or ISDN equipment. However, these methods only communicate the calling party's information and not the source that prompted the calling party to initiate the call.

Turning now to local service providers and or merchants and their advertising methods, wherein service providers place advertisements promoting their goods and services through various advertising sources, including, but not limited to, print, websites, news papers, magazines, outdoor advertising, radio, and/or television. Local service providers primarily focus the majority of their advertising dollars on yellow page listings as their primary form of advertising, both in print and online, to distribute contact, goods and/or services information to customers seeking said goods and/or services. Examples of these are the regional Bell operating companies' yellow pages and associated websites, such as www.realpages.com, www.yellowpages.com, www.superpages.com and http://yp.yahoo.com. In use, a user of the yellow pages searches for a service provider by searching through an index of service providers within the yellow page book or online at one of the above listed websites. The user selects a provider and telephones the service provider by dialing the phone number listed in such directory or emails the service provider or visits service provider's website and inquires about the service provider's goods and/or services. The service provider who placed the advertisement in the yellow pages, web advertising or any other advertisement typically does not know the advertising source that prompted the user's call, email or website visit, whether yellow page advertisement, service provider's website, word of mouth recommendation or any other advertising source. Now to relate the above methods, the call or inquiry is not made by the advertiser, and therefore, the identification methods set forth above do not identify the advertising source for the recipient of the call, i.e., the service provider. Therefore, these sources nor any other advertising sources, including but not limited to, news papers, magazines, outdoor advertising, radio, television, assist the service provider with identifying whether or not a call, website visit and/or sales lead made to the service provider was identifiably generated by such advertising source(s).

Therefore, for the foregoing reasons, it is readily apparent that there is a need for a method, system and apparatus that can identify the advertising source and/or Internet source of a call, website visit and/or sales lead.

### BRIEF DESCRIPTION

Briefly described, in a preferred embodiment, the present version of the invention overcomes the above-mentioned disadvantage, and meets the recognized need for such an invention by providing a system and method for identifying the source the source of a sales lead, wherein the present invention provides for the recipient of an accepted call or inquiry with the identity of the advertising source that prompted the call or inquiry; thus, communicating such information to the recipient through conventional telecommunications and/or network infrastructure.

According to its major aspects and broadly stated, the present version of the invention in its preferred form is a system and method for identifying the source of a sales lead, comprising, in general, a telecommunications call establishment process, a message retrieval process, a message delivery process, and a communication bridging process.

More specifically, the preferred embodiment of the present version of the invention is a system and method for identifying the source the source of a sales lead, wherein said system receives a call or inquiry from a calling or inquiring party directed to a routing number, the calling party is placed on hold in a first communication connection by such system, a process for retrieval of a message and transfer number associated with the routing number, establishing a second communication connection to a transfer number (the called party), delivering a message over second communication connection to the called party, and bridging said first communication connection to said second communication connection thereby establishing an end-to-end connection.

Alternatively, the first communication connection can be terminated, while the second communication connection is established. The processing of the communication connection can include bridging the first communication connection, forwarding the first communication connection to a forwarding location, placing the first communication connection on hold, accommodation for call waiting, and caller identification. The first message and transfer number connection can be implemented on a network server, an originating switch, an intermediate switch, or a terminating switch. A first message is relayed over the first communication connection before the first and second communication connection is bridged together, i.e., message transmitted from server to calling party.

Preferably, the method and system of the present version of the invention can be implemented on a Public Switched Telecommunications Network; Integrated Services Digital Network; a broad band signaling Integrated Services Digital Network; a packet network or a POTS network utilizing dual-tone-multi-frequency (DTMF) signals; a wireless or mobile network; a voice over internet protocol (VOIP); or any combination of these telecommunication systems or any other communication systems capable of performing the process herein.

Accordingly, a feature and advantage of the present version of the invention is its ability to identify the advertising source that prompted the calling party to make a call.

Another feature and advantage of the present version of the invention is its ability to educate the call recipient about the party initiating the call.

Still another feature and advantage of the present version of the invention is its ability to educate the advertiser about the party initiating the call

Yet another feature and advantage of the present invention is its ability to assist the call recipient and/or advertiser in making advertising decisions.

Yet another feature and advantage of the present invention is its ability to communicate a message as audio, video, graphic or text.

Yet another feature and advantage of the present invention is its ability to allow the call recipient and/or advertiser to identify a call and/or sales lead as a call the recipient and/or advertiser desires to dispute.

Yet another feature and advantage of the present invention is its ability to allow the call recipient and/or advertiser to dispute the sales lead charge for an individual or multiple call(s) and/or sales lead(s).

These and other features and advantages of the present version of the invention will become more apparent to one skilled in the art from the following description and claims when read in light of the accompanying drawings.

### BRIEF DESCRIPTION OF THE DRAWINGS

The present version of the invention will be better understood by reading the Detailed Description of the Preferred and Alternate Embodiments with reference to the accompanying drawing figures, in which like reference numerals denote similar structure and refer to like elements throughout, and in which:

FIG. 1 is a block diagram of a computer system.

FIG. 2 is a block diagram of a communications system implemented by the system in FIG. 1.

FIG. 3 is a block diagram of a communication path for an end-to-end call from a calling party to a called party.

FIG. 4 is a block diagram of a communication path for an end-to-end call from a calling party to a called party as routed through a special server and intermediate central office switches.

FIG. 5 is a flow diagram of a communication method, according to the preferred embodiment of the present version of the invention, implemented by the system in FIG. 2.

FIG. 6 is a screen shot of a user interface of the method of FIG. 5.

FIG. 7 is a flow diagram of a communication method, according to the preferred embodiment of the present version of the invention, implemented by the system in FIG. 2.

FIG. 8 is a screen shot of a user interface of the method of FIG. 7.

FIG. 9 is a screen shot of a user interface of the method of FIG. 7.

FIG. 10 is a screen shot of a user interface of the method of FIG. 7.

### DETAILED DESCRIPTION OF THE PREFERRED AND ALTERNATIVE EMBODIMENTS

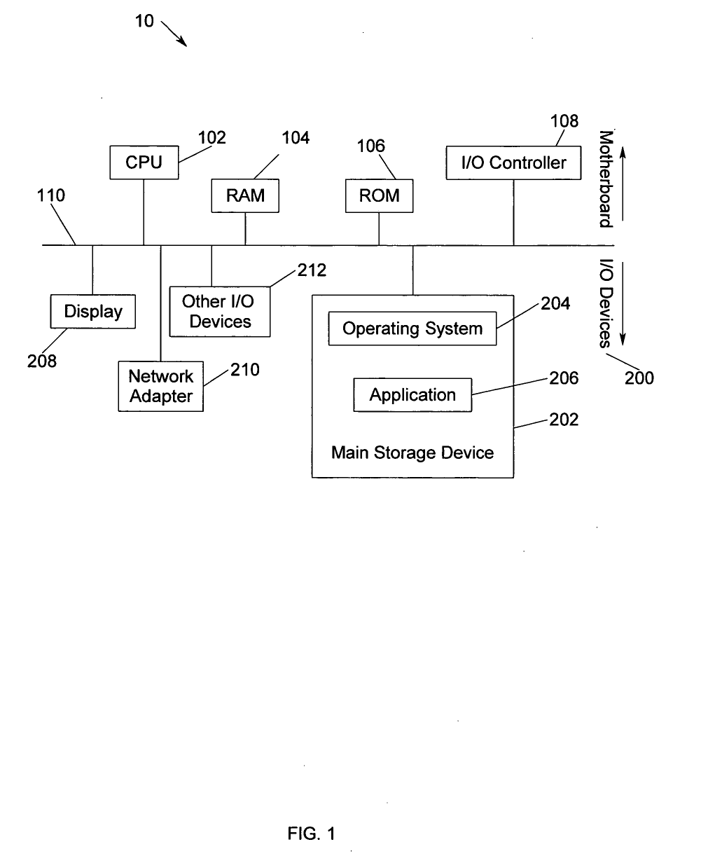

In describing the preferred and alternate embodiments of the present version of the invention, as illustrated in FIGS. 1-10, specific terminology is employed for the sake of clarity. The present version of the invention, however, is not intended to be limited to the specific terminology so selected, and it is to be understood that each specific element includes all technical equivalents that operate in a similar manner to accomplish similar functions.

As will be appreciated by one of skill in the art, the present version of the invention may be embodied as a method, data processing system, or computer program product. Accordingly, the present version of the invention may take the form of an entirely hardware embodiment, entirely software embodiment or an embodiment combining software and hardware aspects. Furthermore, the present version of the invention may take the form of a computer program product on a computer-readable storage medium having computer-readable program code means embodied in the medium. Any suitable computer readable medium may be utilized including hard disks, ROM, RAM, CD-ROMs, electrical, optical or magnetic storage devices.

The present version of the invention is described below with reference to flowchart illustrations of methods, apparatus (systems) and computer program products according to embodiments of the present version of the invention. It will be understood that each block or step of the flowchart illustrations, and combinations of blocks or steps in the flowchart illustrations, can be implemented by computer program instructions. These computer program instructions may be loaded onto a general purpose computer, special purpose computer, or other programmable data processing apparatus to produce a machine, such that the instructions, which execute on the computer or other programmable data processing apparatus create means for implementing the functions specified in the flowchart block or blocks/step or steps.

These computer program instructions may also be stored in a computer-usable memory that can direct a computer or other programmable data processing apparatus to function in a particular manner, such that the instructions stored in the computer-usable memory produce an article of manufacture including instruction means which implement the function specified in the flowchart block or blocks/step or steps. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks/step or steps.

Accordingly, blocks or steps of the flowchart illustrations support combinations of means for performing the specified functions, combinations of steps for performing the specified functions and program instruction means for performing the specified functions. It will also be understood that each block or step of the flowchart illustrations, and combinations of blocks or steps in the flowchart illustrations, can be implemented by special purpose hardware-based computer systems, which perform the specified functions or steps, or combinations of special purpose hardware and computer instructions.

Computer program for implementing the present version of the invention may be written in various object-oriented programming languages, such as conventional C calling. However, it is understood that other source or object oriented programming languages, and other conventional programming languages could be utilized without departing from the spirit and intent of the present version of the invention.

Referring now to FIGS. 1-10, the present version of the invention in its preferred embodiment is a method, system or apparatus for identifying the source that prompted a call and/or sales lead on a communication network by providing the recipient of an accepted call with such identifying information. For brevity, several elements in the figures described below are represented as monolithic entities. However, as would be understood by one skilled in the art, these elements each may include numerous interconnected computers and/or components designed to perform a set of specified operations and/or dedicated to a particular geographical region.

Referring now to FIG. 1, there is illustrated a block diagram of a computer system 10 that provides a suitable environment for implementing embodiments of the present version of the invention. The computer architecture shown in FIG. 1 is divided into two parts—motherboard 100 and the input/output (I/O) devices 200. Motherboard 100 includes bus 110 which interconnects major subsystems such as central processing unit (CPU) 102, random access memory (RAM) 104, input/output (I/O) controller 108, and read-only memory (ROM) 106, also known as firmware. A basic input output system (BIOS) containing the basic routines that help to transfer information between elements within the computer is stored in ROM 106 or operably disposed in RAM 104. The computer further includes I/O devices such as main storage device 202 for storing an operating system 204 and application program(s) 206 and display 208 for visual output, respectively. Main storage device 202 is connected to CPU 102 through a main storage controller (represented as 108) connected to bus 110. Network adapter 210 allows the computer system to send and receive data through communication devices. One example of a communications device is a modem including both cable and digital subscriber line (DSL). Other examples include a transceiver, a set-top box, a communication card, a satellite dish, an antenna, or any other network adapter capable of transmitting and receiving data over a communications link that is either a wired, optical, or wireless data pathway.

Many other devices or subsystems 212 may be connected in a similar manner, including but not limited to, devices such as microphone, speakers, sound card, keyboard, pointing device (e.g., a mouse), floppy disk, CD-ROM player, printer and/or modem each connected via I/O adapter. Also, it is not necessary for all of the devices shown in FIG. 1 to be present to practice the present version of the invention, as discussed below. Furthermore, the devices and subsystems may be interconnected in different ways from that shown in FIG. 1. The operation of a computer system such as that shown in FIG. 1 is readily known in the art and is not discussed in detail in this application, so as not to overcomplicate the present discussion.

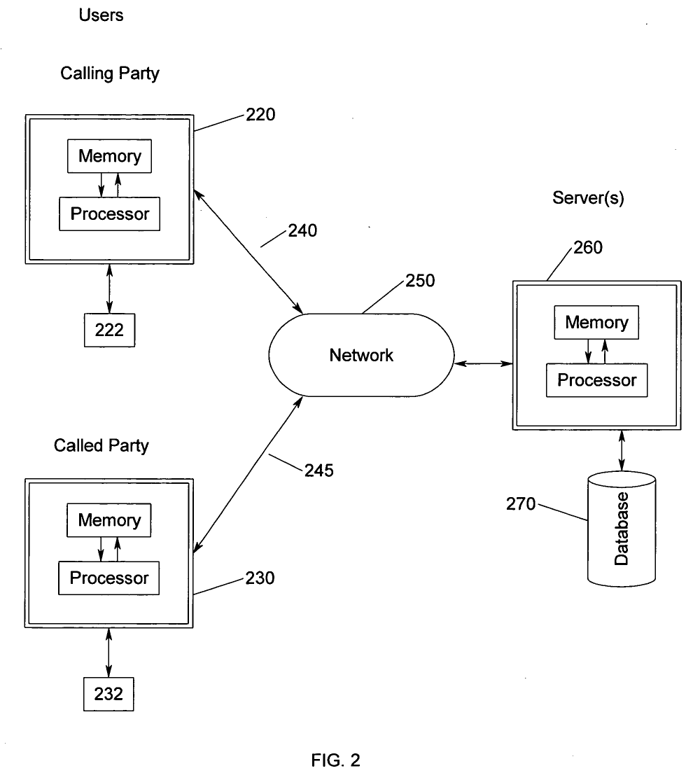

Referring now to FIG. 2, there is illustrated a diagram depicting an exemplary system in which concepts consistent with the present version of the invention may be implemented. Examples of each element within the communication system of FIG. 2 are broadly described above with respect to FIG. 1. In particular, the server system 260, calling party 220, and called party 230 have attributes similar to computer system 10 of FIG. 1 and illustrates one possible implementation of that system. The communication system 200 includes one or more users (calling party 220 and called party 230), and one or more server device 260, and a network 250, which could be, for example, the Internet. User systems 220 and 230 each include a computer-readable medium, such as random access memory, coupled to a processor. The processor executes program instructions stored in memory. Calling party 220 and called party 230 preferably include a microphone, speaker(s), and a sound card (222 and 232 respectively), and may also include a number of additional external or internal devices, such as, without limitation, a mouse, a CD-ROM, a keyboard, a display, a storage device and other attributes similar to computer system 10 of FIG. 1. The communications system 200 typically includes one or more user system 220 and 230. For example, the user system 220 and 230 may include one or more general-purpose computers (e.g., personal computers), one or more special purpose computers (e.g., devices specifically programmed to communicate with each other and/or the server system 260), a workstation, a server, a device, an analog telephone adapter (ATA), an internet protocol phone, wireless internet protocol phone, Wi-Fi internet protocol phone, a digital assistant or a “smart” cellular telephone or pager, a component, other equipment, or some combination of these elements that is capable of responding to and executing instructions.

Similar to user system 220 and 230, server system 260 includes a computer-readable medium, such as random access memory, coupled to a processor. The processor executes program instructions stored in memory. Server system 260 may also include a number of additional external or internal devices, such as, without limitation, a mouse, a CD-ROM, a keyboard, a display, a storage device and other attributes similar to computer system 10 of FIG. 1. Server system 260 may additionally include a secondary storage element, such as database 270 for storage of data and information. Server system 260, although depicted as a single computer system, may be implemented as a network of computer processors. Memory in server system 260 contains an application program and other applications 280 (not shown). For example, the server system 260 may include one or more general-purpose computers (e.g., personal computers), one or more special purpose computers (e.g., devices specifically programmed to communicate with each other) a workstation, packet-switching technology, or other equipment, or some combination of these elements that is capable of responding to and executing instructions.

Communications system 200 is capable of delivering and exchanging voice and/or data between user systems 220 and 230, server system 260, through communication links 240 and/or network 250. Through user system 220 and 230, users can communicate over network 250 with each other and with other systems and devices coupled to network 250, such as server system 260. The communications link 240 typically includes a delivery network 250 making a direct or indirect communication between the user system 220 and the server system 260, irrespective of physical separation. Examples of a network 250 include the Internet, the World Wide Web, WANs, LANs, analog or digital wired and wireless telephone networks (e.g. PSTN, ISDN, or XDSL), radio, television, cable, satellite, and/or any other delivery mechanism for carrying and/or transmitting data or other information. The communications link 240 may include, for example, a wired, wireless, cable, optical or satellite communication system or pathway.

Application program 280 has attributes similar to application 206 of FIG. 1, and preferably includes voice over internet protocol (VOIP) software, which operably locates, receives, identifies, and transmits relevant information in response to communications from user 220 and 230. In particular, a user operating user system 220 requests a communication path between user 220 and 230. Server system 260 and its application program 280 retrieve user 230 internet protocol (IP) address and ping user 230 to see if user 230 is available and willing to accept a VOIP communication. If user 230 responds in the affirmative server system 260 connects users 220 and 230 and server system 260 facilitates communication between user 220 and 230 via communications system 200. Internet protocol preferably encodes users 220 and 230 analog voice signal into digital data, the data is arranged in packets, and the packets are transmitted to the recipient (either user 220 or 230) over communications system 200. At the other end (either user 220 or 230) the packets are decoded and converted back into analog voice signals. In general, systems for communicating via VOIP, packet-switching, IP gateways, analog telephone adapters, IP phones, and packet-switched phone networks are well known in the art. Moreover, it is not necessary for all of the devices shown in FIG. 2 to be present to practice the present version of the invention.

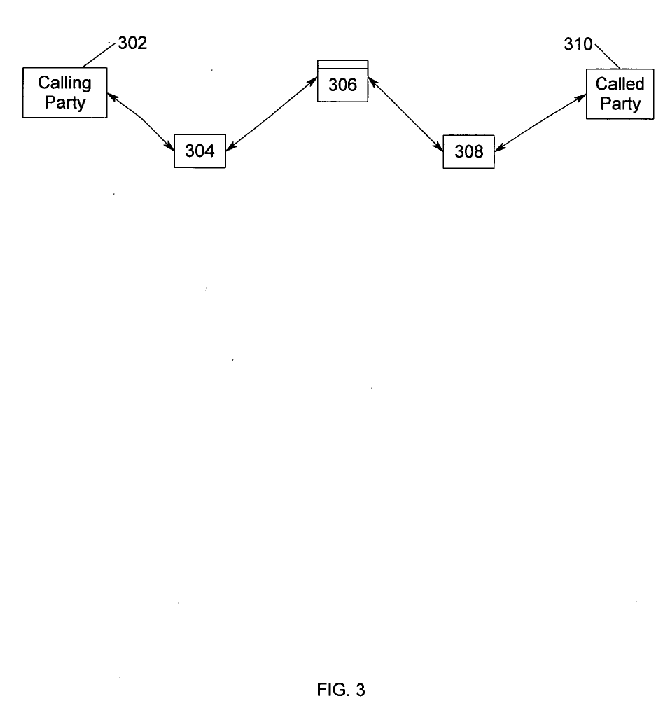

FIG. 3 illustrates a communication path for an end-to-end call from a calling party 302 to a called party 310 according to one exemplary embodiment of the present invention. Examples of several elements within the communication system of FIG. 3 are broadly described above with respect to FIG. 1.

Referring now to FIG. 3, current technology establishes a connection between these two users when calling party 302 places a call to called party 310. This is achieved by the signaling system 300. The signaling system attempts to confirm a clear line via a specific route from calling party 302 to originating switch 304 through the central office 306, to the appropriate terminating switch 308, and finally to called party 310. The communications route is established by the signaling system 300 via connections through the various required paths until the line is complete from end-to-end. When a call is made between two parties, the connection is maintained for the duration of the call. Because you are connecting two points in both directions, the connection is called a circuit. This is the foundation of the Public Switched Telephone Network (PSTN).

One such procedure for determining a clear line connection involves a three-stage process. First, the calling party station 302 preferably establishes a connection to its originating switch 304; second, the originating switch 304 preferably establishes a connection to the destination or terminating switch 308, via any intermediate devices such as through the central office 306 (for illustrative purposes, the described embodiments of the present invention assume that the calling and called parties are served by different switches, however, the principles of the present invention are equally applicable where both the calling and called parties are served by the same switch, i.e., originating and terminating switches are the same); and, finally, the terminating switch 308 preferably establishes a connection to the called party station 310. When all stages of the connection process are completed a clear line is established between calling 302 and called 310 party stations.

Once the completed connection is established, the called party 310, by picking up the handset of his or her ringing telephone, accepts the call and the originating switch 304 completes the connection between the calling and called party stations, and end-to-end communication (between calling and called party stations) may then begin.

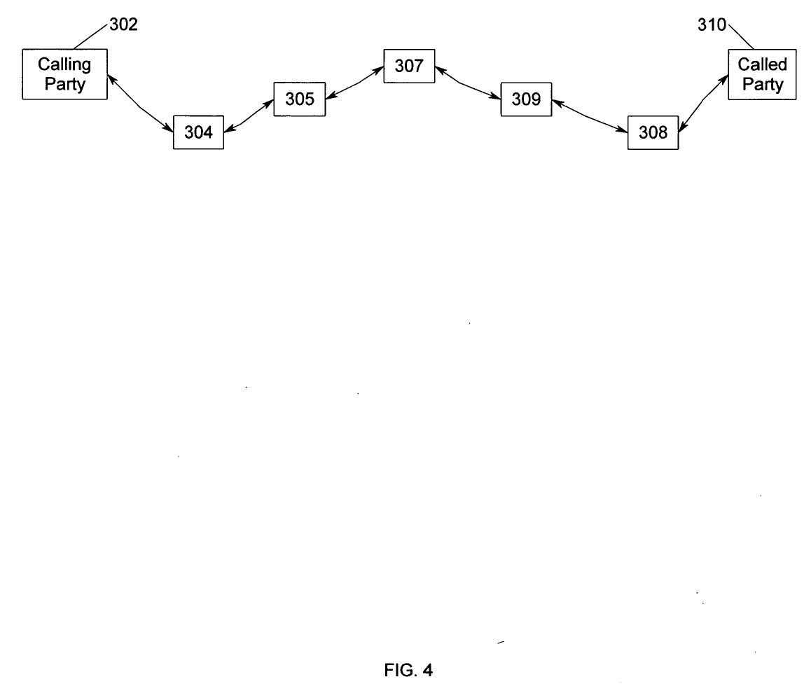

FIG. 4 illustrates a communication path for an end-to-end call from a calling party 302 to a called party 310 routed through a special server and intermediate central office switches according to one exemplary embodiment of the present invention. Examples of several elements within the communication system of FIG. 4 are broadly described above with respect to FIG. 1.

Referring now to FIG. 4, there is illustrated a second end-to-end communication path between a calling party 302 and a called party 310. The signaling system attempts to confirm a clear line via a specific route from the calling party 302 to originating switch 304 through the central office 306, which in this embodiment preferably includes central office intermediate switches 305 and 309 and special network server 307, to the appropriate terminating switch 308, and, finally, to the called party 310. The route is established by the signaling system 400 via connection through the various required paths until the line is complete from end-to-end.

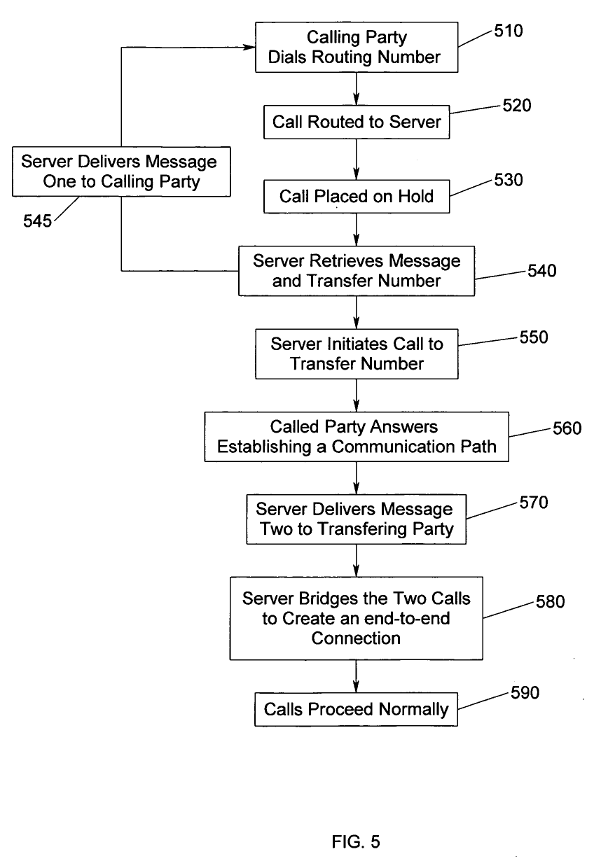

Referring now to FIG. 5, there is illustrated a preferred flow diagram in which calling party, called party and server interact according to a process 500 within the communication systems 200, 300, 400 or any combination of such systems set forth herein. Calling party preferably has attributes comparable to those described above with respect to calling party 220 and 302. Called party preferably has attributes comparable to those described above with respect to calling party 230 and 310. Server preferably has attributes comparable to those described above with respect to server system 260, 306 and 307. Server is preferably interconnected to calling party and/or called party through a known or described delivery network and/or telecommunications system. The network preferably has attributes comparable to those described above with respect to network 250. Procedure 500 preferably can be implemented by such telecommunication system 200, 300, 400 or other similar hardware, software, device, computer, computer system, equipment, component, application, code, storage medium, or propagated signal.

As illustrated in FIG. 5, process 500 starts with step 510 wherein a calling party dials a routing number. The dialing of the routing number routes a call from the calling party to a server or switch (step 520), wherein a first communication path is established between calling party and server. Routing number preferably is a telephone number owned by a third party such as an advertising source, communication source or any other referral, call and/or sales lead generator.

In step 530 of process 500 server places calling party's call on hold or momentarily holds the communication path. In step 540 of process 500 server retrieves message one, message two and transfer number stored in server database, wherein the message(s) and transfer number are records linked to routing number. Message one preferably is an audio message such as “Thanks for using Company Name” (such as BeanPool) from advertising source; however, any audio, video, graphic or text message may be used as message one.

In step 545 of process 500, server delivers message one to calling party via first communication path. In step 550 of process 500, server initiates a second call by dialing transfer number. Transfer number is a telephone number owned by called party such as a service provider who is advertising with advertising source, medium or any other referral, call and/or sales lead generator.

Upon transfer number (called party) answering in step 560 a second communication path is established between server and transfer number (called party). In step 570 of process 500, server delivers message two to transfer number via second communication path. Message two preferably is an audio message such as “An incoming call (or sales lead) from Company Name” (such as BeanPool) or “Company Name at your service” from advertising source; however, any audio, video, graphic or text message may be used as message two.

In step 580 of process 500, server will bridge the two calls to create an end-to-end connection between calling party and transfer number (called party) and the call can proceed normally in step 590. Moreover, it is not necessary for all of the steps shown in FIG. 5 to be present to practice the present version of the invention.

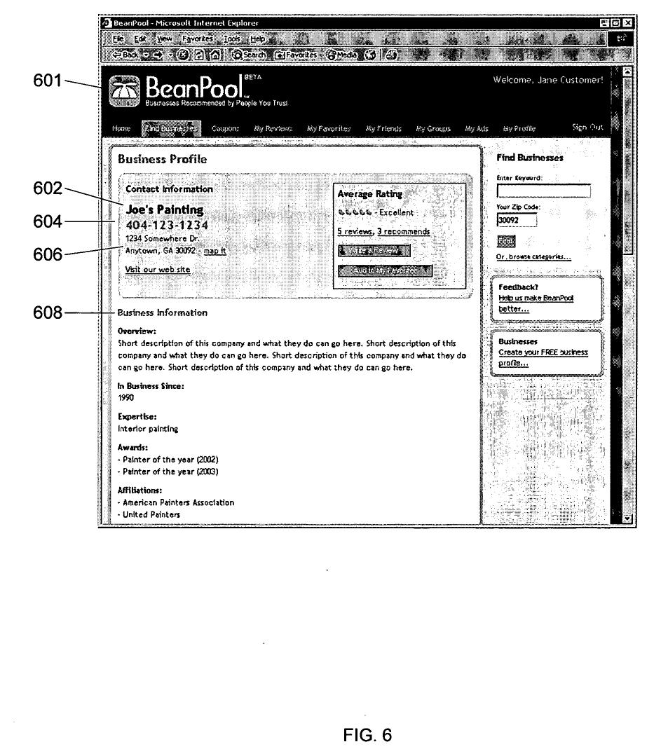

Referring now to FIG. 6, there is illustrated a preferred screen shot of a service provider 601 (called party) landing page 600, wherein a user 220 can locate among other things the service provider's name 602, routing number 604, service provider address 606, and/or service provider's information 608 regarding the goods and/or services offered by this service provider, logo, pricing, URL, terms and conditions, warranty, license, certification, testimonials (contact information for those providing testimonies), quotes, pictures, audio, video or other such service provider information as would meet the purpose described herein. User 220 (calling party) and server 260 preferably interact within the communication system 200 of FIG. 2. Other reports, information and/or formats for presenting, entering and/or selecting information are contemplated in the present version of this invention.

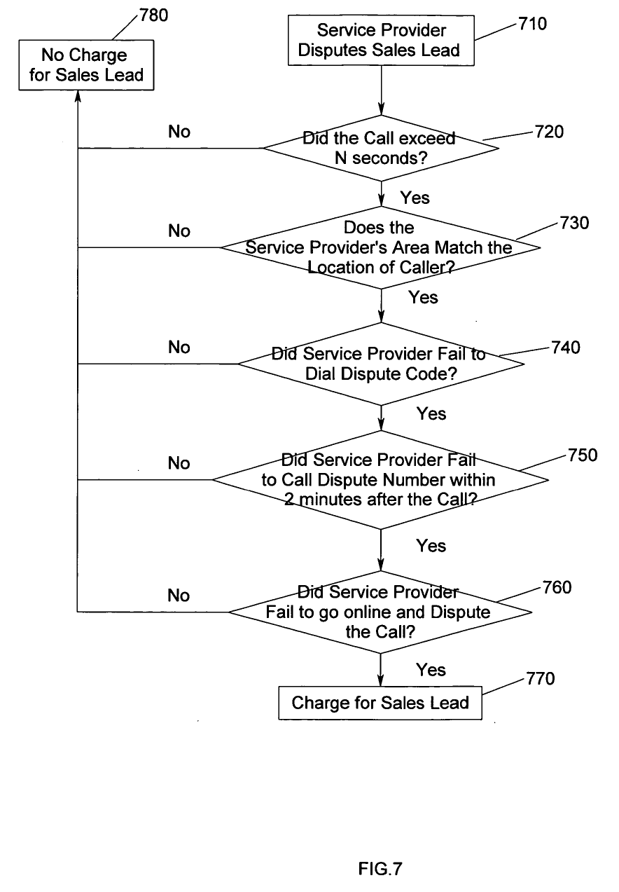

Referring now to FIG. 7, there is illustrated a preferred flow diagram in which user (service provider) and server 260 interact according to a process 700 within the communication system 200 of FIG. 2. Service provider preferably has attributes comparable to those described above with respect to user system 220. Server preferably has attributes comparable to those described above with respect to server system 260. Server is preferably interconnected to service provider through a known or described delivery network. The network preferably has attributes comparable to those described above with respect to network 250. Procedure 700 preferably can be implemented by such telecommunication system 200, 300, 400 or other similar hardware, software, device, computer, computer system, equipment, component, application, code, storage medium, or propagated signal.

As illustrated in FIG. 7, process 700 starts with step 710 wherein service provider has the option to dispute a referral, click thru, call and/or sales lead charge. In step 720 of process 700, server calculates the duration of time (T₁) of the call between calling party and service provider (called party) or time (T₁) that user spent at service provider's website. If the time (T₁) is not greater than fifteen seconds in duration then service provider is not charged a referral, click thru, call and/or sales lead charge; however, other durations for time (T₁) are contemplated in the present version of this invention. Otherwise service provider is charged a referral, click thru, call and/or sales lead charge.

Thereafter, process 700 proceeds to the next step 730 of process 700, wherein server determines whether calling party is within service provider's service area or the area where service provider delivers goods. If calling party is not within service provider's service area or where service provider delivers goods then service provider is not charged a referral, click thru, call and/or sales lead charge. Otherwise service provider is charged a referral, click thru, call and/or sales lead charge.

Thereafter, process 700 proceeds to the next step 740 wherein server determines whether service provider dialed a sales lead dispute code while remaining on the call. If service provider did dial a sales lead dispute code while remaining on the call then service provider is not charged a referral, click thru, call and/or sales lead charge. Otherwise service provider is charged a referral, click thru, call and/or sales lead charge.

Thereafter, process 700 proceeds to the next step 750 wherein server calculates the duration of time (T₂) after the call between calling party and service provider (called party) terminated and when service provider dialed a sales lead dispute phone number. If the time (T₂) is not greater than two minutes in duration then service provider is not charged a referral, call and/or sales lead charge; however, other durations for time (T₂) are contemplated in the present version of this invention. Otherwise service provider is charged a referral, call and/or sales lead charge.

Thereafter, process 700 proceeds to the next step 760 of process 700, wherein server calculates the duration of time (T₃) after the user left service provider's website and when service provider generated an electronic notice to advertising source challenging the referral. If the time (T₃) is not greater than one minute in duration then service provider is not charged a referral, click thru, call and/or sales lead charge; however, other durations for time (T₃) are contemplated in the present version of this invention. Otherwise service provider is charged a referral, click thru and/or sales lead charge. Moreover, it is not necessary for all of the steps shown in FIG. 7 to be present to practice the present version of the invention.

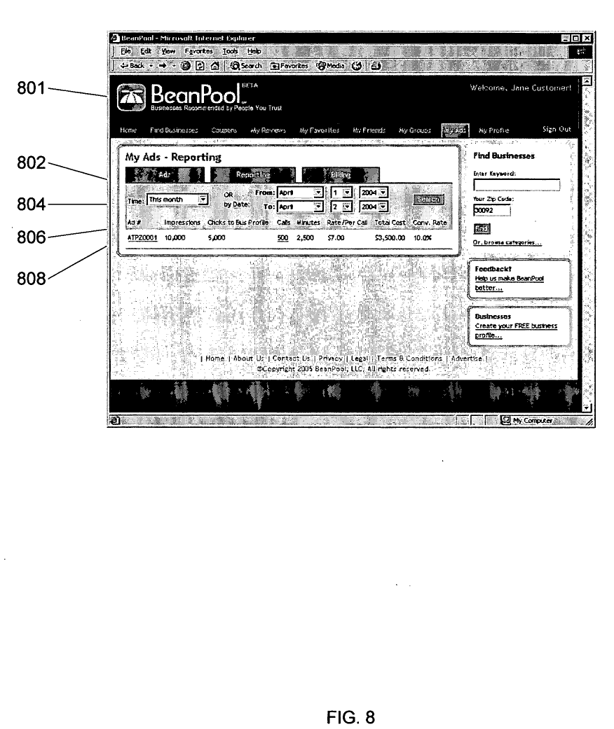

Referring now to FIG. 8, 9, and 10, service provider and advertising source interact within the communication system 200 of FIG. 2. Service provider preferably has attributes comparable to those described above with respect to user system 220. Advertising source preferably has attributes comparable to those described above with respect to server system 260. Advertising source is preferably interconnected to service provider through a known or described delivery network. The network preferably has attributes comparable to those described above with respect to network 250.

Referring now to FIG. 8, there is illustrated a preferred screen shot 800 of an advertising source 801, wherein a service provider represented by ATPZ0001 preferably discloses selection tabs to review or place advertising with advertising source 801, generate advertising reports from previous advertising with advertising source 801, and/or review advertising billing or pay for advertising 802. Drop down windows 804 preferably discloses selection boxes for setting a time frame of an advertising billing period. After service provider selects the time frame of an advertising billing period and presses search, advertising source generates a billing report 808 with the following service provider data, including, but not limited to, Ad number, Impressions, Clicks to Business Profile, Calls, Minutes, Rate Per Call, Total Cost of Advertising, and/or Conversion Ratio, and categorized similarly as shown in 806. It is contemplated that other reports, information and/or formats for presenting, entering and/or selecting information are contemplated in the present version of this invention.

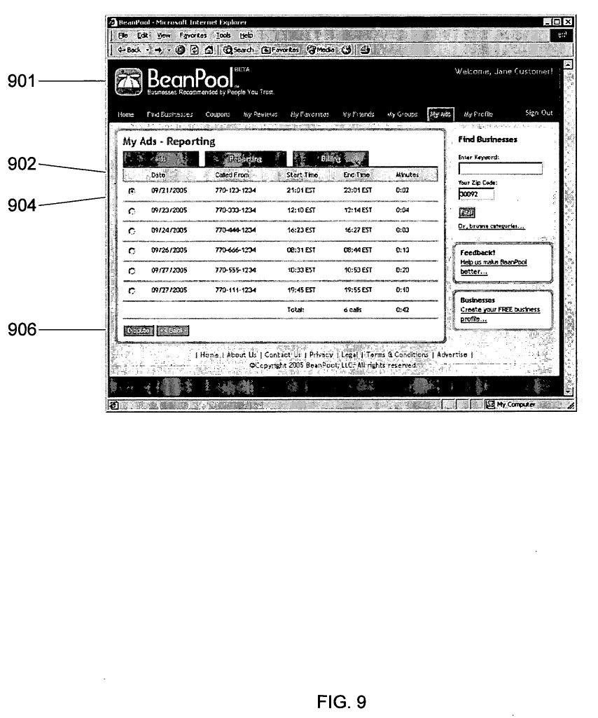

Referring now to FIG. 9, there is illustrated a preferred screen shot 900 of an advertising source 901, wherein a service provider (called party) represented in FIG. 8 requests a detailed list of the call(s) or click thru(s) from advertising source to service provider. Advertising source 901 generates the call and/or click thru list for the time frame requested by service provider with the following per call or click thru information, including but not limited to, Date (date of call or click thru), Called From (identifying the calling party or click thru party), Start Time, End Time, Minutes (duration of call or time spent at service providers landing page or website) 902. Service provider preferably selects a call(s) or click thru(s) by clicking the radial button next to the row identifying the call or click thru 904. Upon service provider clicking the dispute button 906 service provider preferably sends advertising source a notice that service provider disputes a charge for the selected call or click thru as a referral, click thru and/or sales lead charge. It is contemplated that other reports, information and/or formats for presenting, entering and/or selecting information are contemplated in the present version of this invention.

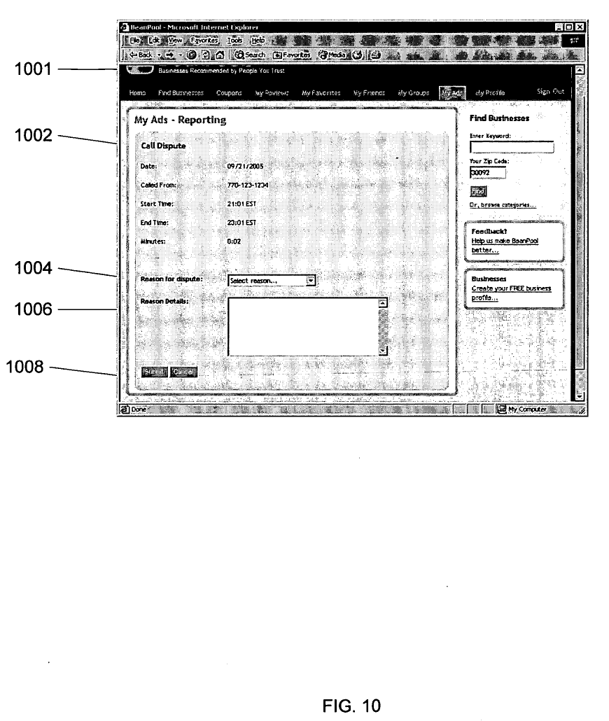

Referring now to FIG. 10, there is illustrated a preferred screen shot 1000 of an advertising source 1001, wherein a service provider (called party) represented in FIG. 9 disputes a charge for the selected call or click thru as a referral, click thru and/or sales lead charge. Based on the selection and submission in FIG. 9, advertising source 1001 generates and transmits the screen shot 1000 to service provider. The selected call or click thru information is displayed therein, including but not limited to, Date (date of call or click thru), Called From (identifying the calling party or click thru party), Start Time, End Time, Minutes (duration of call, time spent at service providers landing page and/or website) 1002. In addition, FIG. 10 discloses a drop down window selection box preferably populated with reasons for disputing the call or click thru, including, but not limited to, duration of call, time spent at website, or outside service area. Moreover, FIG. 10 discloses a text entry box for service provider to enter details and/or comments supporting its position for disputing the call or click thru as a referral, click thru and/or sales lead charge. By clicking the submit button the call or click thru dispute information will be sent to advertising source 1001. It is contemplated that other reports, information and/or format of information are contemplated in the present version of this invention.

Although the description given above includes specific examples of currently envisioned embodiments of the computer program, method, system, and/or apparatus, these possibilities should not be understood as limiting the scope of the present version of the invention but rather as providing illustrations of some of the embodiments that are now preferred. Several examples of alternate embodiments are also described and various other alternatives, adaptations, and modifications may be made within the scope of the present version of the invention. Merely listing or numbering the steps or blocks of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the claims that follow herein and their legal equivalents, rather than the examples given in the specification, should determine the scope of present version of the invention.

What is claimed is:

1. A method for identifying the source of a sales lead, said method comprising the steps of:
receiving a call over a first communication connection from a calling party, said call directed to a routing number;
establishing a second communication connection to a called party, said call directed to a transfer number;
identifying a party associated with said routing number; and
bridging said first communication connection to said second communication connection thereby establishing an end-to-end connection.

2. The method of claim 1, wherein said first communication connects said calling party to a server.

3. The method of claim 1, wherein said first communication connection is placed on hold.

4. The method of claim 2, wherein said second communication connects said called party to a server.

5. The method of claim 2, wherein said server retrieves said transfer number.

6. The method of claim 2, wherein said server retrieves a message.

7. The method of claim 6, wherein said server delivers said message to said calling party over said first communication connection.

8. The method of claim 2, wherein said server initiates said second communication connection to said transfer number.

9. The method of claim 2, wherein said server establishes a second communication connection to said transfer number.

10. The method of claim 6, wherein said server delivers said message to said called party over said second communication connection.

11. The method of claim 10, wherein said message identifies said call as being initiated by an advertising source over said second communication connection.

12. The method of claim 1, wherein said method is implemented on a network server.

13. The method of claim 12, wherein said network server is an advertising source.

14. A telecommunications system comprising:
means for receiving a call over a first communication connection from a calling party, said call directed to a routing number;
means for establishing a second communication connection to a called party, said call directed to a transfer number;
means for identifying a party associated with said routing number; and
means for bridging said first communication connection to said second communication connection thereby establishing an end-to-end connection.

15. The telecommunications system of claim 14, further comprising a means for establishing said first communication, wherein said calling party is connected to a server.

17. The telecommunications system of claim 14, further comprising a means for placing said first communication connection on hold.

18. The telecommunications system of claim 14, further comprising a means for establishing said second communication, wherein said called party is connected to a server.

19. The telecommunications system of claim 15, further comprising a means for retrieving said transfer number from said server.

20. The telecommunications system of claim 15, further comprising a means for retrieving a message from said server.

21. The telecommunications system of claim 20, further comprising a means for said server to deliver said message to said calling party over said first communication connection.

22. The telecommunications system of claim 15, further comprising a means for initiating said second communication connection between said server and said transfer number.

23. The telecommunications system of claim 15, further comprising a means for establishing said second communication connection between said server and said transfer number

24. The telecommunications system of claim 20, further comprising a means for said server to deliver said message to said called party over said second communication connection.

25. The telecommunications system of claim 14, further comprising a means for identifying said call as being initiated by an advertising source over said second communication connection.

26. The telecommunications system of claim 14, further comprising a means for implementing said system on a network server.

27. The telecommunications system of claim 26, wherein said network server is an advertising source.

28. A method for disputing a sales lead, said method comprising the steps of:
determining the duration of a call between a service provider and a caller; and
charging said service provider for said call, wherein if said duration of said call between said service provider and said caller exceeds at least fifteen second.

29. The method of claim 28, further comprising determining whether said caller is within a service area of said service provider.

30. The method of claim 29, further comprising charging said service provider for said call, wherein if said caller is within said service area of said service provider.
